(19) United States
(12) Patent Application Publication
(10) Pub. No.: US 2018/0172650 A1
(43) Pub. Date: Jun. 21, 2018

(54) ADSORPTION DEVICE FOR TRACE DETECTORS

(71) Applicant: Morpho Detection, LLC, Newark, CA (US)

(72) Inventors: Wilhelm P. Platow, Newburyport, MA (US); Hanh T. Lai, Arlington, MA (US); Evan V. Lane, Stoneham, MA (US); Bradley D. Shaw, Plaistow, NH (US)

(21) Appl. No.: 15/380,585

(22) Filed: Dec. 15, 2016

(51) Int. Cl. G01N 31/22; G01V 11/00

(52) U.S. Cl. CPC G01N 31/22; G01V 11/002

(57) ABSTRACT

The present disclosure is directed to adsorption devices for use in substance detection systems and methods of using same. In particular, the present disclosure is directed to adsorption devices that allow for both the optional refilling of adsorption material and the optional regeneration of a dryer.

### BACKGROUND OF THE DISCLOSURE

The present disclosure is directed to adsorption devices for use in substance detection systems and methods of using same. In particular, the present disclosure is directed to adsorption devices that allow for both the optional refilling of adsorption material and the optional regeneration of a dryer. The adsorption devices are used in substance detection systems that are used, for example, to detect chemical substances, such as explosives, narcotics, pesticides, and chemical warfare agents.

Substance detectors are used for detection of explosives and narcotics. Such detectors require the use of a dryer supplying a continuous flow of dry air with very low moisture content, otherwise it would be difficult for detection algorithms to identify compounds due to humidity variations in ambient air. Dryers have a limited life-time, however, so typically they get refilled with fresh adsorption materials such as molecular sieve and/or activated charcoal or the dryers get regenerated by heating and purging them for an extended period of time. In the latter case, a second dryer is usually switched to in order to provide continuous operation while the first dryer regenerates. In handheld or portable detection systems for which space and power availability is very limited, the two-dryer switching design is not ideal.

There remains a need, therefore, for an optional regenerative dryer in a handheld/portable trace system that contains only one active dryer, which the user can choose to refill with fresh adsorption material (for example, when continuous and immediate operation is desired) or the user can choose to regenerate the dryer within the system (for example, if daily operation allows idle or overnight downtime with wall power).

### BRIEF DESCRIPTION OF THE DISCLOSURE

In one embodiment of the present disclosure, an adsorption device for use in a substance detector is disclosed. The device comprises a heater; a purge valve; at least one removable plug; and, at least one adsorption material compartment.

In another embodiment of the present disclosure, a substance detector is disclosed. The substance detector comprises a housing configured to receive at least one substance of interest; a pump in flow communication with the housing; and, an adsorption device in flow communication with the housing and pump, the adsorption device comprising a heater; a purge valve; at least one removable plug; and, at least one adsorption material compartment.

In yet another embodiment of the present disclosure, a method for operating a substance detector for detecting a substance of interest is disclosed. The method comprises directing an air flow through the substance detector, wherein the substance detector comprises a housing configured to receive the substance of interest; a pump in flow communication with the housing; and, an adsorption device in flow communication with the housing and pump, the adsorption device comprising a heater; a purge valve; at least one removable plug; and, at least one adsorption material compartment comprising an adsorption material; optionally refilling the adsorption material; and, optionally regenerating the heater.

### BRIEF DESCRIPTION OF THE DRAWINGS

FIG. 1 is an exemplary embodiment of a substance detector in accordance with the present disclosure.

FIG. 2 is an exemplary embodiment of an adsorption device in accordance with the present disclosure.

FIG. 3 is an exemplary embodiment of a method for operating a substance detector in accordance with the present disclosure.

FIG. 4 is an exemplary embodiment of a graph of an exemplary regeneration cycle of a dryer in accordance with the present disclosure.

### DETAILED DESCRIPTION OF THE DISCLOSURE

The present disclosure is directed to adsorption devices for use in substance detection systems and methods of using same.

In substance detectors, to maintain adequate detection levels, a dryer gets typically refilled with fresh/dry molecular sieve on a regular basis or the dryer gets regenerated during a heat/purge cycle (which saves consumable cost). Space, weight, and power constraints of handheld/portable detectors make it undesirable to use a second dryer (which would enable uninterrupted operation while the first dryer regenerates). Another option is the use of a replaceable dryer cartridge which can be replaced quickly, but this option has the disadvantage of needing to have an external regeneration station.

The present disclosure solves the dryer life-time issue for substance detectors, such as, for example, handheld/portable trace systems, by using an adsorption device that is equipped with a heater and a purge valve for optional regeneration (e.g., overnight or during idle time) to save consumable cost, and a removable plug that enables the user to refill the dryer with fresh/dry molecular sieve in case there is no time for regeneration.

As used herein, the term “moisture” includes water vapor, humidity, water, and any condensed or diffused liquid. Thus, as used herein, a “moisture sensor” that measures the moisture content within a device includes measuring the water vapor content, the humidity level, the water level and any condensed or diffused liquid level within the device. Thus, when the “moisture content” is measured and/or lowered, in some embodiments, the moisture content is a humidity level, a water vapor level, a water level, or combinations thereof.

In some embodiments of the present disclosure, an adsorption device for use in a substance detector is disclosed. The device comprises a heater, a purge valve, at least one removable plug, and at least one adsorption material compartment. In some embodiments, the device is configured to fit in at least one of a portable substance detector, a desktop detector, a cart detector, a floor and rack mounted detector, a portal monitor (high-throughput system) and combinations thereof. In some embodiments, the detector is a handheld substance detector.

In some embodiments, the device further comprises at least one of an insulator, an O-ring seal, tubing and mesh. In some embodiments, the device further comprises at least one temperature sensor. In some embodiments, the temperature sensor includes at least one of a resistance temperature detector (RTD), a thermistor, a temperature diode and a thermocouple. In some embodiments, the device further comprises at least one proportional-integral-derivative (PID) controller.

In some embodiments of the present disclosure, the device further comprises at least one moisture sensor. As noted above, the moisture sensor measures the amount of moisture within the device. Thus, the moisture sensor measures, in some embodiments, a water vapor level, a water level, a humidity level and the like. The moisture sensor alerts the user of the device if the moisture content is at a level that requires the device to be serviced, either by refilling the adsorption material or regenerating the device.

In some embodiments, the adsorption device includes more than one adsorption material compartment. Each compartment, whether one or more are present, comprises at least one desiccant. The desiccant adsorbs moisture within the device (e.g., water vapor, water, etc.). In some embodiments, the desiccant includes at least one of a molecular sieve, silica gel, a hydrogel, activated charcoal and combinations thereof. In some embodiments, the molecular sieve comprises at least one of zeolite, porous glass, active charcoal, potassium oxide, sodium hydroxide, aluminum oxide, calcium sulfate, magnesium oxide, silicon oxide, clay and combinations thereof. In some embodiments, the molecular sieve is selected from the group consisting of a 5A sieve, a 4A sieve, a 3A sieve, an A sieve, a 13X sieve and combinations thereof.

In some embodiments, the device includes multiple adsorption material compartments. In some embodiments, the multiple compartments are connected in series. In some embodiments, the multiple compartments are connected in parallel. Each adsorption material compartment comprises an opening. The opening allows for the adsorption material to be placed within the compartment. In some embodiments, each adsorption material compartment comprises a plug. The plug covers the opening, and, in some embodiments, the plug is a removable plug. When the plug is a removable plug, a user is able to remove the plug such as, for example, when the adsorption material within the compartment has become saturated and needs to be refilled. In these embodiments, the user removes the plug and then switches out the used adsorption material for a new, fresh adsorption material. This, in turn, allows for the substance detector to continue functioning without suffering from the negative effects that occur when the moisture content within the detector is too high. Thus, in some embodiments, the device comprises multiple compartments, each with an opening, and multiple plugs to cover each opening (i.e., one plug to cover each opening). In some embodiments, each plug comprises an O-ring.

In some embodiments of the present disclosure, the device comprises a heater. In some embodiments, the heater is located between multiple adsorption material compartments. In these embodiments, the heater is located between the compartments whether the compartments are connected in series or in parallel. In some embodiments, the heater wraps around the adsorption material compartment or compartments. In some embodiments, the heater protrudes into the adsorption material compartment or compartments.

In another embodiment of the present disclosure, a substance detector is disclosed. The substance detector comprises a housing configured to receive at least one substance of interest; a pump in flow communication with the housing; and, an adsorption device in flow communication with the housing and pump, the adsorption device comprising a heater; a purge valve; at least one removable plug; and, at least one adsorption material compartment.

Suitable substance detectors include, but are not limited to, an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof. In some embodiments, the detector is an IMS detector.

The adsorption device of the present disclosure is configured to work in any substance detector, including, but not limited to, portable detectors, handheld detectors, a desktop detector, a cart detector, a floor and rack mounted detector and combinations thereof.

The substance detectors receive and detect substances of interest. In some embodiments, the at least one substance of interest includes at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant and combinations thereof. In some embodiments, the substance of interest includes at least one of nitrates, chlorates, perchlorates, nitrites, chlorites, permanganates, chromates, dichromates, bromates, iodates, and combinations thereof.

In some embodiments, the substance of interest comprises at least one of ammonium nitrate (AN), ammonium nitrate fuel oil (ANFO), urea nitrate (UN), trinitrotoluene (TNT), ethylene glycol dinitrate (EGDN), nitroglycerin (NG), pentaerythritol tetranitrate (PETN), high melting explosive (HMX), triacetone triperoxide (TATP), hexamethylene triperoxide diamine (HMTD), erythritol tetranitrate (ETN), nitromethane, hydrogen peroxide and Research Department Explosive (RDX).

In some embodiments, the substance detector further comprises an inlet for receiving a sample to be tested for the presence of at least one substance of interest; an ionization chamber; a drift chamber; and, at least one moisture sensor. In some embodiments, the substance detector further comprises at least one of a desorber, a dryer, an ion collector, a doping chamber, a plumbing system, a gas line in flow communication with a dryer, a gas line in flow communication with a doping chamber, and an exhaust outlet.

In some embodiments, the substance detector comprises more than one moisture sensor, more than two moisture sensors, more than three moisture sensors, or more than four moisture sensors. The number of moisture sensors used varies and is determined by the user of the detector.

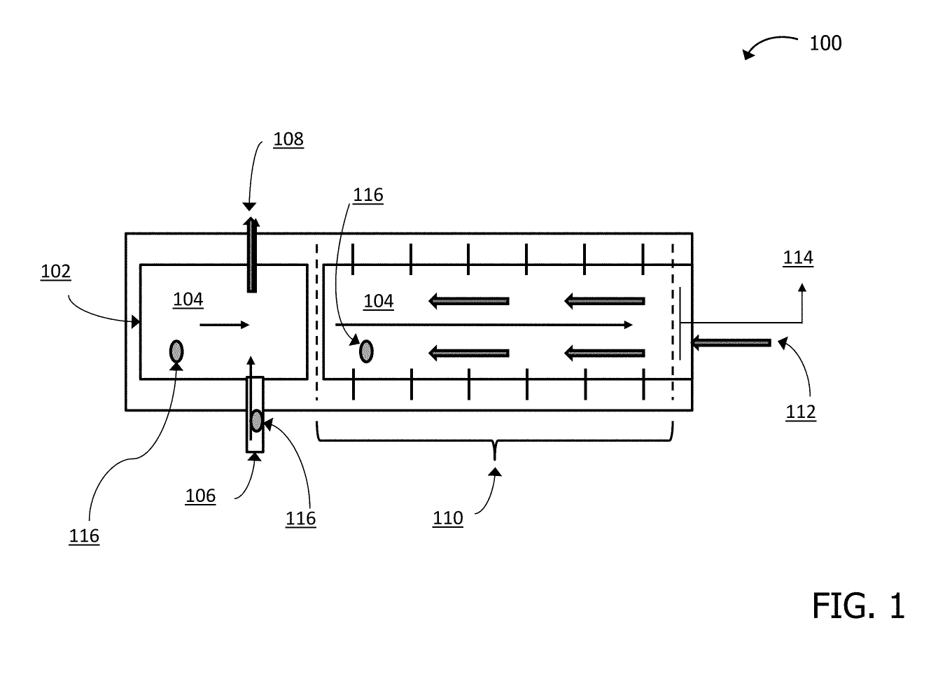

FIG. 1 is an exemplary embodiment of a substance detector in accordance with the present disclosure. In the exemplary embodiment, substance detector 100 comprises an ionization chamber 102 and a drift chamber 110. The detector 100 includes a sample inlet 106 from which the substance of interest enters into the detector 100. Once the substance of interest enters the ionization chamber 102, the substance is ionized to form ions of the substance of interest 104. The ions of the substance of interest 104 travel from the ionization chamber 102 into the drift chamber 110. The detector 100 further includes an exhaust outlet 108. A drift gas 112 enters into the drift chamber 110 and flows either toward the ionization chamber 102 or away from the ionization chamber 102. The detector 100 further includes an amplifier signal 114. Within the exemplary embodiment, the detector 100 includes moisture sensors 116. The sensors 116 are located within the sample inlet 106, within the ionization chamber 102 and within the drift chamber 110. The moisture sensors 116 measure the moisture content within each of the sample inlet 106, the ionization chamber 102 and the drift chamber 110.

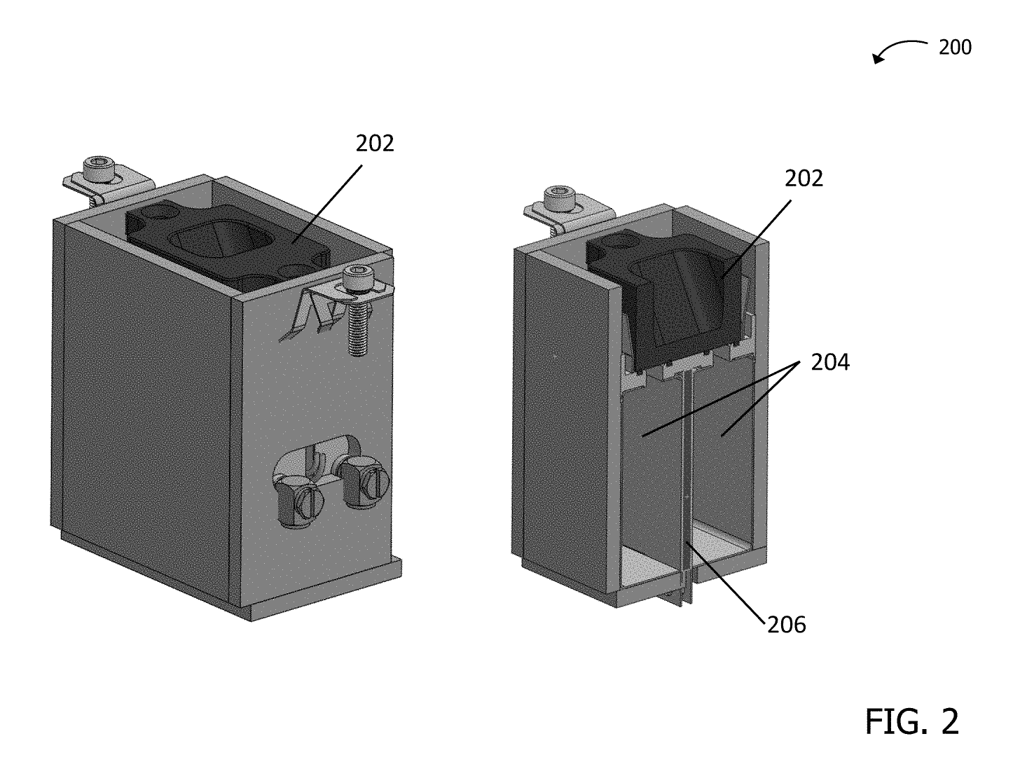

FIG. 2 is an exemplary embodiment of an adsorption device 200 in accordance with the present disclosure. In some embodiments, the adsorption device 200 is a dryer. The device 200 comprises a removable plug 202, multiple adsorption material compartments 204 and a heater 206. In this embodiment, the device 200 has the option to be either refilled with an adsorption material (e.g., fresh/dry molecular sieve) or regenerated via a heat/purge cycle. In this embodiment, two compartments 204 that are configured to be filled with molecular sieve are separated by walls and a heater 206 allowing optimal heat dissipation with minimal losses. The removable plug 202 seals two openings at the top of each compartment 204 with separate O-rings. Alternatively, two plugs are used (i.e., one for each compartment 204). Additionally, in some embodiments, the heater 206 wraps around the adsorption material compartment 204 or compartments 204. In some embodiments, the heater 206 protrudes into the adsorption material compartment 204 or compartments 204.

In some embodiments, removing the plug 202, dumping out the saturated molecular sieve and refilling it with fresh/dry molecular sieve provides the fastest way of bringing the detector back up and running.

In some embodiments, the heater 206 is used to regenerate the device 200. The heater 206 heats both compartments 204 (for example, to about 200° C. during the heat/purge cycle). A temperature sensor (e.g., RTD or thermo-couple, not shown here) on the outside of one of the compartments 204 (or both) monitors the temperature. A PID controller (not shown) takes the temperature into account and drives the temperature to the desired value. During the regeneration cycle, in some embodiments, the air flow direction is switched and the temperature of the device 200 is raised to about 200° C. so water desorbs from the molecular sieve and gets flushed out by a continuous flow of ambient air. The desorption temperature is dependent on the adsorption material and, in some embodiments, ranges up to about 1000° C. After a period of time, the desorption process is complete and the system cools down. During or after the cool down, the flow direction gets switched back and dry air will be available for standard operation of the detector.

In another embodiment of the present disclosure, a method of operating a substance detector for detecting a substance of interest is disclosed. The method comprises directing an air flow through the substance detector, wherein the substance detector comprises a housing configured to receive the substance of interest; a pump in flow communication with the housing; and, an adsorption device in flow communication with the housing and pump, the adsorption device comprising a heater; a purge valve; at least one removable plug; and, at least one adsorption material compartment comprising an adsorption material; optionally refilling the adsorption material; and, optionally regenerating the heater.

In some embodiments, the method of operating includes operating the substance detector in continuous operation. Thus, contrary to previous substance detectors and substance detection systems, the present disclosure allows for a user to continuously operate, or, if desired, have the option to regenerate the device within the substance detector while maintaining a low moisture content in the detector. That is, the user refills the adsorption device within the detector with fresh adsorption material when continuous and immediate operation is desired or the user regenerates the dryer within the system, for example, if daily operation allows for idle or overnight downtime with wall power.

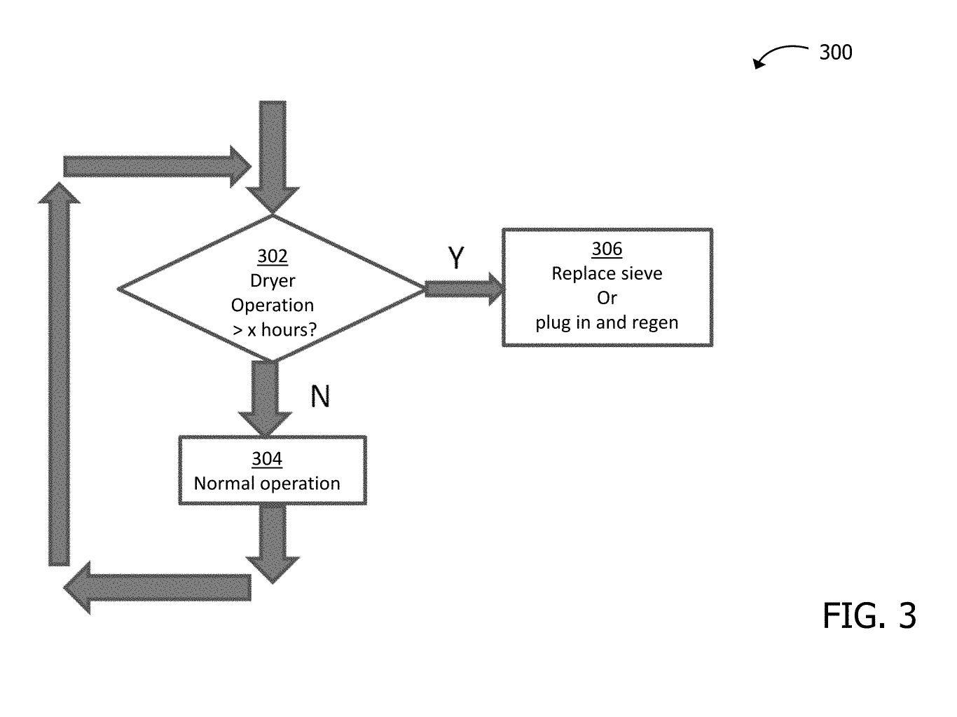

FIG. 3 depicts an exemplary block diagram for an embodiment of an adsorption device (i.e., a dryer) in accordance with the present disclosure. In the method 300, step 302 continuously monitors the length of time that the dryer has been continuously operating. When a typical saturation time within the device is about to be approached, step 306 prompts a user to either refill the adsorption material (e.g., molecular sieve) or to start a regeneration cycle of the dryer. If, at step 302, it is determined that the dryer has not approached saturation, then step 304 provides for normal operation of the dryer and thus the substance detector. In some embodiments, the detector is a handheld portable detector and the present disclosure provides for the optional refilling/regeneration steps all in one detector without the need of having multiple dryers.

Alternatively, instead of a timed approach, in some embodiments a humidity sensor is used and the decision to start a refill of the adsorption material or a regeneration cycle is based on whether the humidity level is too high.

In some embodiments, refilling the adsorption material comprises removing the plug, removing the adsorption material and refilling the compartment with a new adsorption material. As used herein, the term “refilling” includes exchanging the adsorption material, either in whole or in part. That is, when the adsorption material is refilled, it is refilled/exchanged either in part, or in whole, depending upon the preference of the user as well as the moisture content within the device.

In some embodiments, regenerating the heater comprises increasing a temperature of the heater to at least about 100° C., at least about 150° C., at least about 200° C., at least about 250° C., or at least about 300° C. In some embodiments, regenerating the heater comprises increasing the temperature of the heater from about 200° C. to about 250° C. Once the temperature of the heater has reached a desired temperature, the temperature of the heater is maintained at the desired temperature for a period of time of at least about 30 minutes, at least about 1 hour, at least about 2 hours, at least about 5 hours, or at least about 7 hours. In some embodiments, the temperature of the heater is maintained at a desired temperature for a period of time of from about 1 hour to about 5 hours.

The regeneration cycle of the adsorption device is determined based on the amount of moisture content within the adsorption device, as well as the characteristics of the ambient air used to flush out the moisture within the device. In particular, the regeneration cycle timing and the ambient air quality are factors of the type of adsorption material being used and the amount of moisture within the device and/or detector. In some embodiments, the regeneration cycle is at least about 30 minutes, at least about 1 hour, at least about 2 hours, at least about 5 hours, at least about 7 hours, or at least about 10 hours. In some embodiments, the regeneration cycle is up to about 30 minutes, up to about 1 hour, up to about hours, up to about 5 hours, up to about 7 hours, or up to about 10 hours. That is, the regeneration cycle includes all regeneration times between 0 minutes and up to about 30 minutes, about 1 hour, about 2 hours, about 5 hours, about 7 hours and about 10 hours. In some embodiments, the regeneration cycle is from about 30 minutes to about 10 hours.

As noted in FIG. 3, in some embodiments a user is prompted to either refill the adsorption material or start a regeneration cycle of the adsorption device. In some embodiments, a user is prompted after at least about 1 hour of operation of the substance detector, after at least about 5 hours of operation of the substance detector, after at least about 20 hours of operation of the substance detector, after at least about 50 hours of operation of the substance detector, or after at least about 100 hours of operation of the substance detector. In some embodiments, a user is prompted to either refill the adsorption material or start a regeneration cycle after from about 1 hour to about 100 hours of operation of the substance detector, after from about 1 hour to about 50 hours of operation of the substance detector, or after from about 1 hour to about 5 hours of operation of the substance detector.

During the regeneration cycle, in some embodiments, the temperature within at least one adsorption material compartment is measured. In some embodiments, the temperature is measured with a PID controller. In some embodiments, the PID controller increases the temperature in a controlled manner, keeps the temperature constant during the regeneration cycle, or both.

In some embodiments, during the regeneration cycle, an air flow direction of the air passing through the adsorption device is switched. That is, the air flow direction is switched after the regeneration cycle has begun, and, once the regeneration cycle is finished, the air flow direction is switched back to the original direction. As a result, the moisture content is lowered by driving/flushing out the moisture with ambient air and the moisture is moved outside of the device and/or detector via, for example, a two-way valve.

In some embodiments, a user is prompted to either refill the adsorption material or start a regeneration cycle once the moisture content within the adsorption device reaches a certain level. In some embodiments, a user is prompted to refill the adsorption material when the moisture content within the adsorption device is at least about 50 ppm, at least about 100 ppm, or at least about 500 ppm.

In some embodiments, a user is prompted to either refill the adsorption material or start a regeneration cycle once the moisture content within the substance detector reaches a certain level. In some embodiments, a user is prompted to refill the adsorption material when the moisture content within the substance detector is at least about 50 ppm, at least about 100 ppm, or at least about 500 ppm.

When the moisture content within the adsorption device, the substance detector, or both, has reached a level (e.g., greater than 50 ppm) that the user would like to lower, then the moisture content is lowered by optionally refilling the adsorption material or regenerating the adsorption device. In some embodiments, the moisture content is lowered within the device, the detector, or both, when the moisture content is from about 50 ppm to about 5,000 ppm in the device, the detector, or both. In some embodiments, the refilling of the adsorption material, the regeneration of the device, and both, lowers the moisture content within the device, the detector, or both, to less than about 5,000 ppm, less than about 1,000 ppm, less than about 500 ppm, or less than about 50 ppm. In some embodiments, the moisture content within the device, the detector or both is lowered to from about 100 ppm to about 500 ppm.

As noted elsewhere in the present disclosure, in some embodiments, measuring and lowering the moisture content includes measuring and lowering the humidity level within the device, the detector, or both. In some embodiments, when the humidity level within either the device, the detector, or both, has reached a relative humidity percentage of from about 0.1% to about 5% at a temperature range of from about 15° C. to about 30° C., a user is prompted to lower the humidity level within either the device, the detector, or both. In some embodiments, the humidity level is lowered to a relative humidity percentage of less than about 3%, or from about 0.1% to about 3% within the device, the detector, or both.

In some embodiments, regenerating the adsorption device includes lowering the pressure within the device. Thus, the regeneration includes, in some embodiments, lowering the pressure within the device, heating the device (to, for example, lower the moisture content therein), or combinations thereof.

### EXAMPLE

The following example describes or illustrates various embodiments of the present disclosure. Other embodiments within the scope of the appended claims will be apparent to a skilled artisan considering the specification or practice of the disclosure as described herein. It is intended that the specification, together with the Example, be considered exemplary only, with the scope and spirit of the disclosure being indicated by the claims, which follow the Example.

### Example 1

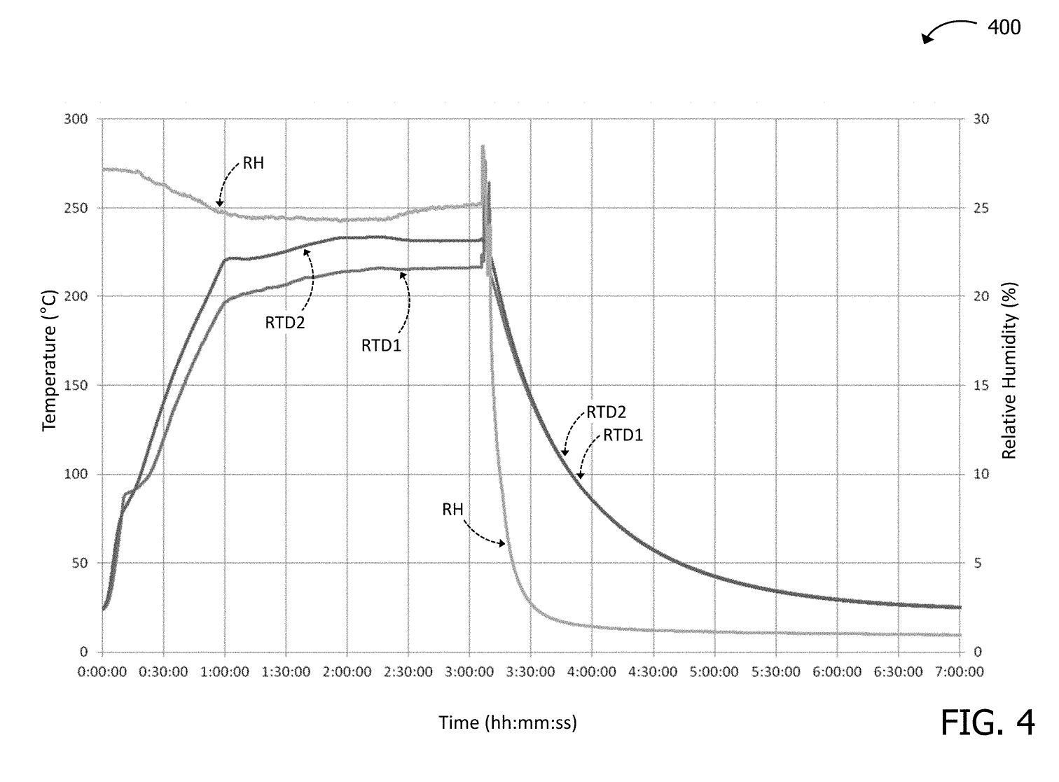

Example 1 is an exemplary embodiment of a regeneration cycle (FIG. 4, 400) in accordance with the present disclosure. In this example, a moisture sensor was used to monitor relative humidity (RH) (ambient temperature was about 24° C. (i.e., about room temperature)) and two resistance temperature detectors (RTD1 and RTD2) were used for temperature measurements. The dryer needed 1 hour to reach a regeneration temperature of 210° C.-230° C. That temperature was maintained for another 2 hours. As shown in FIG. 4, the dryer temperature cooled down to about 50° C. within about 1-2 hours of the peak dryer temperature. The humidity level, however, dropped to acceptable levels after only about 1 hour. Thus, Example 1 demonstrated that the total regeneration cycle to lower the moisture content to acceptable levels within the substance detector took only about 4 hours. Additionally, another advantage of the present disclosure is that instead of going through the brief regeneration cycle, the saturated molecular sieve could have been replaced with a fresh/dry molecular sieve as part of the same detector, thus providing the user with the advantageous option of refilling the adsorption material or conducting a brief regeneration cycle in order to improve the function and lower the moisture content of the substance detector.

Exemplary embodiments of substance detection systems for determining the presence of substances of interest, and methods of operating such systems are not limited to the specific embodiments described herein, but rather, components of systems and/or steps of the methods may be utilized independently and separately from other components and/or steps described herein. For example, the methods may also be used in combination with other systems requiring determining the presence of substances of interest, and are not limited to practice with only the substance detection systems and methods as described herein. Rather, the exemplary embodiment is implemented and utilized in connection with many other substance detection applications that are currently configured to determine the presence of substances of interest.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An adsorption device for use in a substance detector, the adsorption device comprising:
a heater;
a purge valve;
at least one removable plug; and,
at least one adsorption material compartment.

2. The device of claim 1, wherein the device is configured to fit in at least one of a portable substance detector, a desktop detector, a cart detector, a floor and rack mounted detector, a portal monitor (high-throughput system) and combinations thereof.

3. The device of claim 2, wherein the detector is a handheld substance detector.

4. The device of claim 1, further comprising at least one temperature sensor.

5. The device of claim 1, further comprising at least one moisture sensor.

6. The device of claim 1, wherein the adsorption material comprises at least one of a molecular sieve, silica gel, a hydrogel, activated charcoal and combinations thereof.

7. The device of claim 1, wherein the substance detector includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

8. A substance detector comprising:
a housing configured to receive at least one substance of interest;
a pump in flow communication with the housing; and,
an adsorption device in flow communication with the housing and pump, the adsorption device comprising a heater; a purge valve; at least one removable plug; and, at least one adsorption material compartment.

9. The substance detector of claim 8, wherein the detector is at least one of a portable substance detector, a desktop detector, a cart detector, a floor and rack mounted detector, a portal monitor (high-throughput system) and combinations thereof.

10. The substance detector of claim 9, wherein the detector is a handheld detector.

11. The substance detector of claim 8, wherein the detector includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

12. The substance detector of claim 8, wherein the at least one substance of interest includes at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant and combinations thereof.

13. The substance detector of claim 8, wherein at least one of the substance detector and the adsorption device further comprises at least one temperature sensor.

14. The substance detector of claim 8, wherein at least one of the substance detector and the adsorption device further comprises at least one moisture sensor.

15. A method for operating a substance detector for detecting a substance of interest, the method comprising:
directing an air flow through the substance detector, wherein the substance detector comprises a housing configured to receive the substance of interest; a pump in flow communication with the housing; and, an adsorption device in flow communication with the housing and pump, the adsorption device comprising a heater; a purge valve; at least one removable plug; and, at least one adsorption material compartment comprising an adsorption material;
optionally refilling the adsorption material; and,
optionally regenerating the heater.

16. The method of claim 15, wherein the regenerating includes a regeneration cycle of up to about 10 hours.

17. The method of claim 15, wherein a user is prompted to either refill the adsorption material or start a regeneration cycle.

18. The method of claim 17, wherein the user is prompted when a moisture content within at least one of the device and the detector reaches a pre-determined level, after a pre-determined time period, or combinations thereof.

19. The method of claim 15, wherein regenerating the heater includes at least one of lowering a moisture content and lowering a pressure within the device.

20. The method of claim 15, wherein the air flow direction is switched during the regenerating of the heater.
